(19) United States
(12) Patent Application Publication
(10) Pub. No.: US 2006/0168859 A1
(43) Pub. Date: Aug. 3, 2006

(54) Binocular display system

(76) Inventors: Stephen A. Pombo, Campbell, CA (US); Bor-Yeu Tsaur, Lexington, MA (US); Rodney J. Bumgardner, Los Gatos, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/286,693

(22) Filed: Nov. 23, 2005

Related U.S. Application Data
(60) Provisional application No. 60/631,062, filed on Nov. 24, 2004.
(60) Provisional application No. 60/691,955, filed on Jun. 17, 2005.
(60) Provisional application No. 60/726,006, filed on Oct. 11, 2005.
(60) Provisional application No. 60/736,502, filed on Nov. 14, 2005.

(51) Int. Cl. G09F 7/02

(52) U.S. Cl. 40/611.07

(57) ABSTRACT

A binocular display device or module includes a pair of display panels that are custom aligned with respective viewing optics. The binocular display device has a first lens assembly for viewing the first display panel and a second lens assembly for viewing the second display panel. Alignment fixtures within the binocular display device are used to physically align and fix the optics with the display panels using an alignment system. The alignment system includes a camera system for viewing the first display panel of the binocular display device through the first lens assembly, and the second display panel through the second lens assembly. Display panel alignment indicia can be located on the first and second display panels. A viewing screen system can be included for viewing images of the display panel alignment indicia on the first and second display panels which are provided by the camera system. The viewing screen system can include baseline indicia, whereby the first and second display panels can be adjusted into an alignment position for binocular viewing by adjusting positions of the display panels until the images of the display panel indicia shown on the viewing screen system are located relative to the baseline indicia in a manner that indicates acceptable alignment. Through proper alignment of the binocular display module, a head-mountable display system can be manufactured that is lightweight, comfortable to wear, and easy to carry.

### RELATED APPLICATIONS

This application claims the benefit of U.S. Provisional Application Nos. 60/631,062, filed Nov. 24, 2004, 60/691,955, filed Jun. 17, 2005, 60/726,006, filed Oct. 11, 2005, and Provisional Application, filed Nov. 14, 2005, titled “Compact Head Mounted Display” (Attorney Docket No. 0717.2062-000).

The entire teachings of the above applications are incorporated herein by reference.

### BACKGROUND

Binocular display devices typically include two display panels, such as liquid crystal display (LCD) panels, which are typically viewed through a pair of lens assemblies. Such structures also tend to be fairly heavy, uncomfortable to wear, and difficult to transport.

In order to obtain binocular viewing, the two display panels are aligned so that the images formed on the display panels appear to merge into a single stereoscopic image to the viewer. That alignment step is often limited to steps performed by the user, who is required to adjust the interpupillary distance (IPD) between the exit pupils of the lens assemblies so that they align with the individual's eye pupil spacing. That adjustment works best when the lenses and display panels are themselves properly aligned. Typically, the positions of each lens and display panel are dictated by features on a mounting frame. Further alignment between the lens and display panel may not be practical.

### SUMMARY

Embodiments of the present invention can provide a compact display that can be worn by a user in a similar manner to wearing eyeglasses, or if the user is wearing eyeglasses, the display can be supported at least in part by the eyeglasses. The display can include a nose bridge for resting on a user's nose, and earpiece stems for resting on the user's ears. If the user is wearing eyeglasses, the earpiece stems of the display can have support clip members which can engage and rest on the earpiece stems of eyeglasses for supporting the display. The display can also include a center support clip member which can engage and rest on the top of the frame of the eyeglasses for further supporting the display. The nose bridge can be retracted when the display is worn by a user wearing eyeglasses to accommodate the eyeglasses, or can be deployed when the display is worn by a user not wearing eyeglasses.

Embodiments of the present invention can also provide a compact head mounted display that can be folded in a compact manner for transport or storage. The display can include a housing having at least one LCD panel for viewing, and earpiece stems for resting on the user's ears. The earpiece stems can fold relative to the housing. In addition, each earpiece stem can include at least one intermediate folding joint so that the earpiece stem can be folded to be more compact than conventional earpieces. Each earpiece stem can also include at least one bend to allow folding in close relationship to the housing.

A particular embodiment of a binocular display device can comprise a frame, a first and second display panel, a first and second lens assembly, and a first and second alignment fixture. The first display panel can be mounted to the frame for forming a first image having a first display axis and the second display panel can be mounted to the frame for forming a second image having a second display axis. The first lens assembly can be mounted to the frame and have a first viewing axis and the second lens assembly can be mounted to the frame and have a second viewing axis. The first alignment fixture can be used for aligning the first display axis relative to the first viewing axis and the second alignment fixture can be used for aligning the second display axis relative to the second viewing axis. A fastener can then be used for fixing the first and second alignment fixtures in the respective alignment so that the first and second images are registered when binocularly viewed by a viewer through the first and second lens assemblies.

More particularly, the display panels can be liquid crystal display panels. At least one backlight can be used to illuminate the display panels. The display device can further comprise an interface circuit coupled to the display panels to provide power and a data signal.

Furthermore, the alignment fixtures can allow for vertical and horizontal adjustment of the display panels relative to the frame.

A particular application of the binocular display device is as a head-mountable display. To that end, the display device can further comprise a first earpiece and a second earpiece for mounting the frame to a viewer's head. The earpieces can include a respective hinge disposed along the longitudinal length of each earpiece. In addition, eyeglass mounts can be used to facilitate mounting of the frame to eyeglasses. Those eyeglass mounts can include a retractable nose bridge.

When the components of a binocular display are first assembled, the two display panels are sometimes not aligned in acceptable positions, resulting in poor viewing. Adjusting the display panels by eye can be slow and provide inconsistent results.

An alignment system can be used to more quickly, easily and consistently aligning first and second display panels of a binocular display device into more optimum positions than achieved by previous methods. Such a binocular display device typically has a first lens assembly for viewing the first display panel and a second lens assembly for viewing the second display panel.

The alignment system can include a camera system for viewing or observing the first display panel of the binocular display device through the first lens assembly, and for viewing or observing the second display panel through the second lens assembly. Display panel alignment indicia can be located on the first and second display panels. A viewing screen system can be included for viewing images of the display panel alignment indicia on the first and second display panels which are provided by the camera system. The viewing screen system can include baseline indicia whereby the first and second display panels can be adjusted into an alignment position for binocular viewing by adjusting positions of the display panels until the images of the display panel indicia shown on the viewing screen system are located relative to the baseline indicia in a manner that indicates acceptable alignment.

In particular embodiments, a display panel indicia source can be employed for providing the first and second display panels with the display panel alignment indicia. A viewing screen indicia source system can be employed for providing the viewing screen system with the baseline indicia. The display panel alignment indicia and the baseline indicia can each comprise a crosshair that can be aligned with each other.

The alignment system can include a mounting fixture for securing the binocular display device in a fixed position. The camera system can include a first camera for viewing the first display panel and a second camera for viewing the second display panel. The first and second cameras can be mounted relative to the mounting fixture. The first and second lens assemblies of the binocular display device can each have an optical axis which are spaced apart from each other by a distance D₁. The first and second cameras can be spaced apart from each other about the same distance D₁ for alignment with respective first and second lens assemblies. The first and second cameras can be positioned on opposite sides of a longitudinal axis. The first and second cameras can be prefocused on a location on the longitudinal axis at a distance D₂ which allows the cameras to focus on the first and second display panels when viewed through the first and second lens assemblies of the binocular display device. The viewing screen system can include first and second viewing screens. The first viewing screen is capable of viewing images seen by the first camera and the second viewing screen is capable of viewing images seen by the second camera.

The present system also includes a method of aligning first and second display panels of a binocular display device. Such a binocular display device typically has a first lens assembly for viewing the first display panel and a second lens assembly for viewing the second display panel. A camera system can view or observe the first display panel of the binocular display device through the first lens assembly, and can view or observe the second display panel through the second lens assembly. Display panel alignment indicia can be provided on the first and second display panels. A viewing screen system can view images of the display panel alignment indicia on the first and second display panels which are provided by the camera system. The viewing screen system can include baseline indicia. The first and second display panels can be adjusted into an alignment position for binocular viewing by adjusting the positions of the display panels until the images of the display panel indicia shown on the viewing screen system are located relative to the baseline indicia in a manner that indicates acceptable alignment.

In particular embodiments, the first and second display panels can be provided with the display panel alignment indicia from a display panel indicia source. The viewing screen system can be provided with the baseline indicia from a viewing screen indicia source system. Each display panel alignment indicia and baseline indicia can be displayed as a crosshair that can be aligned with each other.

The binocular display device can be secured in a fixed position with a mounting fixture. The first display panel can be viewed with a first camera of the camera system and the second display panel can be viewed with a second camera of the camera system. The first and second cameras can be mounted relative to the mounting fixture. The first and second lens assemblies of the binocular display device can each have an optical axis which are spaced apart from each other by distance D₁. The first and second cameras can be spaced apart from each other the about same distance D₁ for alignment with respect to first and second lens assemblies. The first and second cameras can be positioned on opposite sides of the longitudinal axis. The first and second cameras can be prefocused on a location on the longitudinal axis at a distance D₂ in order to allow the cameras to focus on the first and second display panels when viewed through the first and second lens assemblies of the binocular display device. Images seen by the first camera can be viewed with a first viewing screen of the viewing screen system, and images seen by the second camera can be viewed with a second viewing screen of the viewing screen system. At least one of the vertical and horizontal positions of the first and second display panels can be adjusted during the alignment process.

During calibration of the alignment system, the camera system can be prefocused on a reference target that is at a location on the longitudinal axis at a distance D₂. The baseline indicia can be calibrated to be located at the proper position on the viewing screen system for the alignment process by projecting images of the reference target viewed by the camera system on the viewing screen system. The position of the baseline indicia can be adjusted on the viewing screen system until the baseline indicia is located relative to the images of the reference target in a manner that indicates acceptable alignment. In some embodiments, the baseline indicia can be superimposed over at least portions of the reference target.

### BRIEF DESCRIPTION OF THE DRAWINGS

The foregoing and other objects, features and advantages of the invention will be apparent from the following description of particular embodiments, as illustrated in the accompanying drawings in which like reference characters refer to the same parts throughout the different views. The drawings are not necessarily to scale, emphasis instead being placed upon illustrating the principles of the invention.

FIG. 1 is a perspective view of an embodiment of a binocular display device.

FIG. 2 is a perspective exploded view of the binocular display device of FIG. 1.

FIG. 3 is a top schematic view of the assembled binocular display device of FIGS. 1 and 2.

FIG. 4 is a schematic drawing of the viewing optics of the binocular display device of FIG. 1 in optical alignment for binocular viewing.

FIG. 5 is a schematic of particular lenses for use in the binocular display device of FIG. 1.

FIG. 6 is a schematic drawing of an embodiment of a binocular display device alignment system.

FIG. 7 is a front schematic view of a display panel of a binocular display device with display alignment indicia projected on the display panel.

FIG. 8 is a perspective view of a viewing screen of the viewing screen system and associated indicia source, both display indicia and baseline indicia being displayed on the viewing screen for use in the alignment process.

FIG. 9 is a schematic drawing showing the lateral adjustment of a display panel.

FIG. 10 is a top schematic view of the camera positions of the binocular display device alignment system.

FIG. 11 is a drawing of a reference target.

FIG. 12 is a perspective view of a particular embodiment of a head-mounted display device incorporating the binocular display module of FIG. 1.

FIGS. 13A-13C are perspective views of a user wearing a particular head mounted display while also wearing eyeglasses.

FIGS. 14A-14B are perspective views of the display of FIGS. 13A-13C with a nose support or bridge retracted exposing a center eyeglass support clip member, and the display with the nose support deployed.

FIG. 15 is a perspective view of an embodiment of a monocular display worn by a user wearing eyeglasses.

FIGS. 16A-16B illustrate examples of other embodiments of eyeglass support clip members.

FIG. 17 is a top view of an embodiment of a head mounted display with the earpiece stems folded.

### DETAILED DESCRIPTION

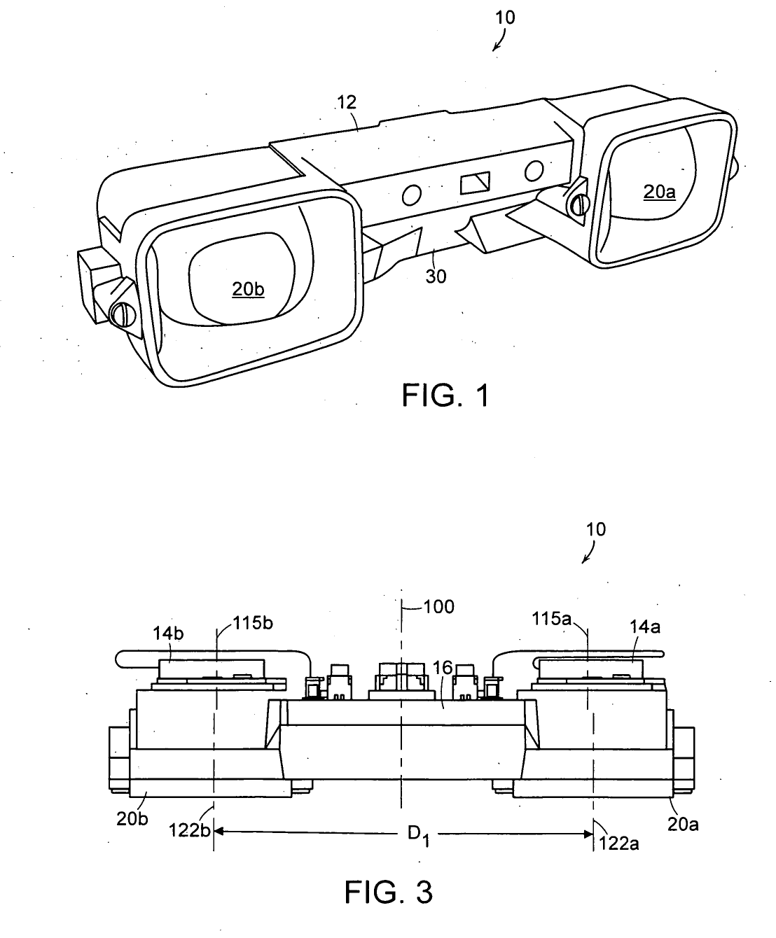

FIG. 1 is a perspective view of an embodiment of a binocular display device 10. Illustrated is one example of a particular binocular display device or module having a main frame or housing 12. The binocular display device 10 also has a first (or right) lens assembly 20A, and a second (or left) lens assembly 20. Also shown is an electronics circuit board 30 that interfaces the display panels with external power and video/image sources. In particular, the binocular display device 10 is a binocular display module (BDM) that can be implemented into a head-mounted display (HMD) device. The main housing structure 12 that joins the optical units together could be fixed (as shown) or could be adjustable for an individual's particular interpupillary distance (IPD).

Commercial embodiments of the binocular display device are available from Kopin Corporation of Taunton, Mass. under part numbers BDM-230K and BDM-922K. Both models are lightweight at 26 grams and 28 grams, respectively. Both models also offer low power consumption at less than 450 mW and 960 mW, respectively. The BDM-230K measures 97.5 mm×22.0 mm×23.75 mm, provides QVGA resolution (320×240) at 230K colors, and offers a 24-degree field of view. The BDM-922K measures 95.6 mm×22.3 mm×31.15 mm, provides VGA resolution (640×480) at 922K colors, and offers a 32-degree field of view. Both models operate on a 3.3 volt power supply and auto-selects NTSC or PAL standard video sources.

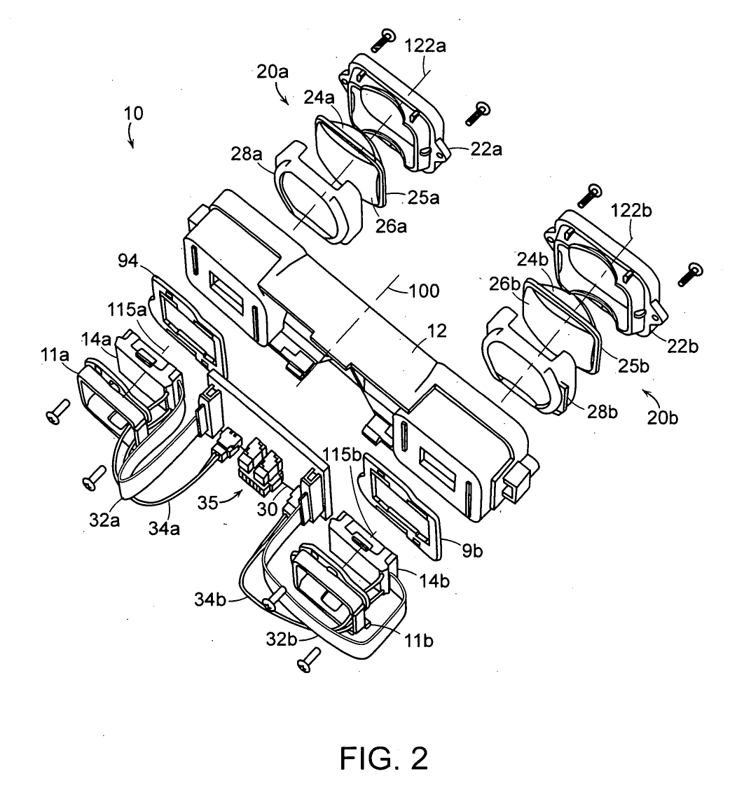

FIG. 2 is a perspective exploded view of the binocular display device of FIG. 1. As shown, the lens assemblies 20A, 20B are mounted to the front (viewer's) side of the main housing 12 by front mounting screws. Each lens assembly 20A, 20B can include one or more lens elements, but is particularly a two-element lens. As such, each lens assembly is shown having a front lens 24A, 24B and a back lens 26A, 26B, which are mated by a lens frame 25A, 25B. The mated lenses are contained within a front cover 22A, 22B and a back cover 28A, 28B. Each assembled lens assembly has an associated optical axis 122A, 122B.

The electrical components are mounted to the rear side of the main housing 12, with rear mounting screws, as shown. Displayed images are formed on a first (or right) display panel 14A, and a second (or left) display panel 14B. The right 14A and left 14B display panels can be liquid crystal display (LCD) panel assemblies and can include LED or other suitable backlighting. Each display panel has an associated optical axis 115A, 1115B. Particularly suitable display panels are CyberDisplay® family microdisplays, which are commercially available from Kopin Corporation of Taunton, Mass. under part numbers KCD-QDNF-AA/BA and KCD-VDCF-AA/BA, although other suitable microdisplays having diagonal dimensions of less than about 25 mm may also be used.

The circuit board 30 is secured to center rear of the main housing 12, although other mounting locations may be used. The circuit board is designed to receive video signal and power inputs from external sources through data and power input ports 35. The right 14A and left 14B display panels can be electrically connected to the circuit board 30 and can be provided with moving picture images such as video images, computerized images, still images, etc. The video/image data signals are provided from the circuit board via a ribbon cable 32A, 32B to each display panel 14A, 14B. The circuit board 30 also provides power to the display panels via a power connection 34A, 34B.

The binocular display device 10 can also include a vertical adjustment frames 9A, 9B and a horizontal adjustment frames 11A, 11B for adjusting the vertical and horizontal positions of each display panel 14A and 14B. The adjustment frames are thus fixtures used to align the various optical axes relative to the center axis 100 of the main housing 12. It should be understood that in certain embodiments, the display panels may have to be adjusted parallel to the axes.

FIG. 3 is a top schematic view of the assembled binocular display device of FIGS. 1 and 2. As shown, the first lens assembly 20A and the second lens assembly 20B are spaced apart by a distance D₁ between their respective optical center line axes 122A, 122B. This provides alignment with the user's right and left eyes, for viewing respective right 14A and left 14B display panels. For best binocular viewing, the displays 14A and 14B should be located in an optimum position. Acceptable binocular viewing can be attained, however, with less than optimum alignment. It should be understood that there would be a range of acceptable positions around the optimum position, depending on engineering, manufacturing tolerances, and end user requirements, etc.

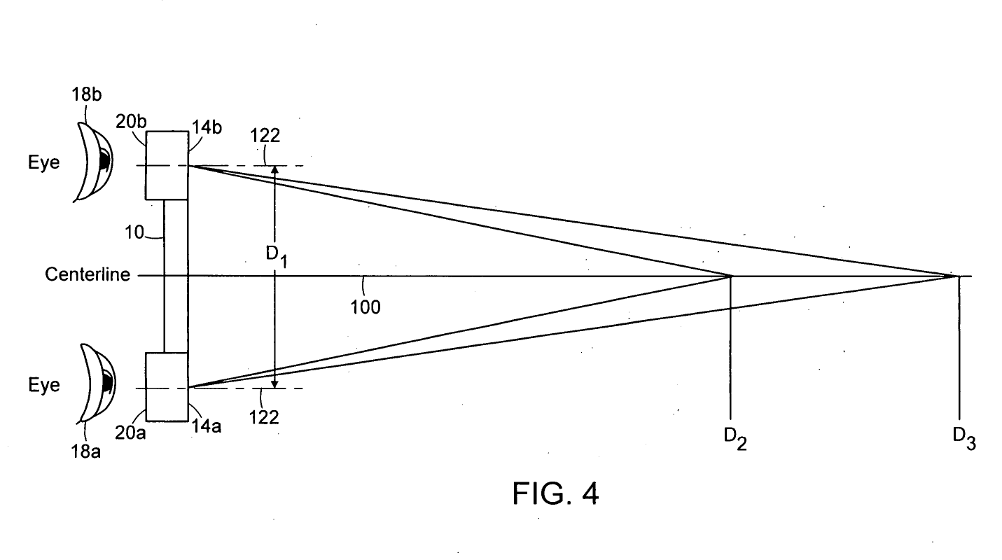

FIG. 4 is a schematic drawing of the viewing optics of the binocular display device of FIG. 1 in optical alignment for binocular viewing. The display panels 14A and 14B can be optically aligned or positioned, as shown, such that the images shown by the display panels 14A and 14B as viewed by the viewer's eyes 18A, 18B through the lens assemblies 20A and 20B, appear to converge or overlap on the same point along the longitudinal center line axis 100, beginning at a distance D₂, and ending at a distance D₃, along the longitudinal center line axis 20. The particular distance D₂ can vary and can be determined by the optics that are chosen for lens assemblies 20A and 20B.

In one possible binocular display device 10, the distance D₁ can be set at a 63.5 mm interpupillary distance (IPD) standard, the distance D₂ can be two meters, ½ diopter and 0.916 degrees (55′), and the distance D₃ can be four meters, ¼ diopter and 0.458 degrees (27.5′). The particular specifications of the optics are as follows:
Field of view: 24°
Eye Relief: 20 mm
Exit Pupil: 9.5 mm
Distortion: 0.15% on axis
   1.4% maximum off axis
Lateral color at corners: 9 mm
The System/Prescription Data is as follows:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$

where c=1/Radius, k=Conic, and r=radial distance from axis. The particular materials used for the lenses are zeonex and polystyrene, but other suitable materials such as zeonex and polycarbonate could be employed.

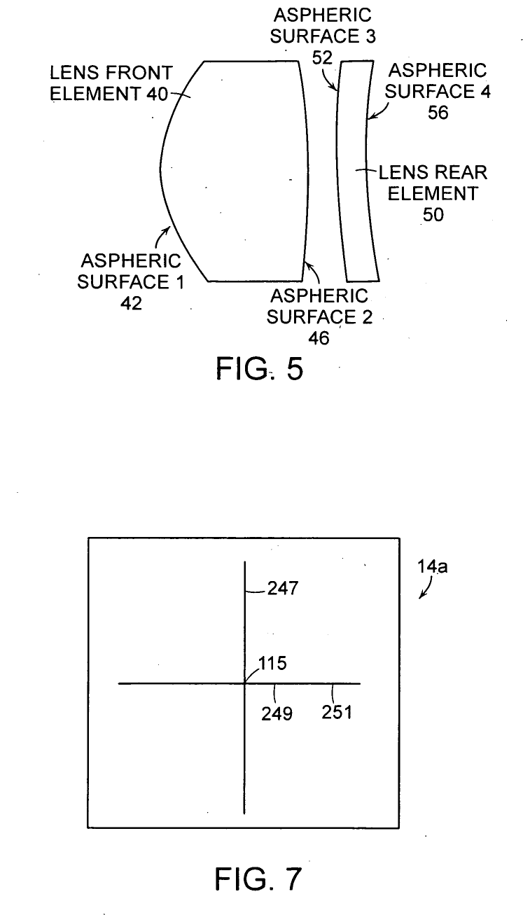

FIG. 5 is a schematic of particular lenses for use in the binocular display device of FIG. 1. As shown, there is a lens front element 40 and a lens rear element 50. The lens front element 40 has an aspheric front surface 42 and an aspheric rear surface 46. The lens rear element 50 has also has an aspheric front surface 52 and an aspheric rear surface 56. In particular, the lenses can be described by the following surface data summary:

| Surf | Type | Comment | Radius | Thickness | Glass | Conic |
|---|---|---|---|---|---|---|
| 7 | EVENASPH | DIFFR ASPHERE | 9.86 | 9.5 | ZEONEX_E48R | −1 |
| | — | — | | | | |
| 9 | BINARY_2 | | 79.7 | 1.75 | | −1 |
| | — | — | | | | |
| 11 | EVENASPH | CORRECTOR PLATE | −19.2 | 1.8 | POLYSTYR | 0 |
| | — | — | | | | |
| 13 | STANDARD | | 50 | 6.25 | | 0 |

The surface data detail is as follows:

| Surface 7: | EVENASPH DIFFR ASPHERE | |
|---|---|---|
| Coeff on r2: | 0 | |
| Coeff on r4: | 7.42e−005 | |
| Coeff on r6: | 1.32e−006 | |
| Coeff on r8: | −7.2e−008 | |
| Coeff on r10: | 1.58e−009 | |
| Coeff on r12: | −1.75e−011 | |
| Coeff on r14: | 8.9e−014 | |
| Coeff on r16: | −1.72e−016 | |
| Aperture: | Rectangular Aperture | |
| X Half Width: | 9.8 | |
| Y Half Width: | 7.35 | |
| Surface 9: | BINARY_2 | |
| Diffract Order: | 1 | |
| Coeff on r2: | 0 | |
| Coeff on r4: | 4.1e−006 | BASE CURVATURE ONLY. |
| Coeff on r6: | −1.51e−005 | FOR DIFFRACTIVE SAG DETAIL. |
| Coeff on r8: | 4.12e−007 | |
| Coeff on r10: | −6.06e−009 | |
| Coeff on r12: | 5.3e−011 | |
| Coeff on r14: | −2.57e−013 | |
| Coeff on r16: | 5.3e−016 | |
| Maximum term: | 3 | |

| | | | |
|---|---|---|---|
| Maximum rad ap: | 1 | DIFFRACTIVE STEP | 1.044 MICRON |
| | | SIZE | |
| Term on P to 2: | −41.2 | EQUIV ADDED | r2: −.0068433 |
| Term on P to 4: | 0.23 | COEFF ON | r4: 3.8203 e−005 |
| Term on P to 6: | −0.0006 | | r6: −9.966 e−008 |

| | |
|---|---|
| Aperture: | Rectangular Aperture |
| X Half Width: | 9 |
| Y Half Width: | 6.75 |
| Surface 11: | EVENASPH CORRECTOR PLATE |
| Coeff on r2: | 0.0584 |
| Coeff on r4: | −0.00027 |
| Coeff on r6: | −9.08e−006 |
| Coeff on r8: | −1.22e−007 |
| Coeff on r10: | 7.47e−009 |
| Coeff on r12: | −6.12e−011 |
| Coeff on r14: | 9.66e−014 |
| Coeff on r16: | −7.21e−016 |
| Aperture: | Rectangular Aperture |
| X Half Width: | 6.7 |
| Y Half Width: | 5 |
| Surface 13: | STANDARD SPHERICAL |
| Aperture: | Rectangular Aperture |
| X Half Width: | 6.7 |
| Y Half Width: | 5 |

The listing of surface 7 sag is as follows (units are millimeters):
Semi diameter of surface 7:1.024836E+001.
Best Fit Sphere curvature: 8.667775E-−002.
Best Fit Sphere radius: 1.153699E+001.

Best Fit Sphere residual: 2.467121E-−001. (rms)

| Y-coord | Sag | BFS Sag | Deviation | Remove |
|---|---|---|---|---|
| 0.000000E+000 | 0.000000E+000 | 0.000000E+000 | 0.000000E+000 | 3.076285E−001 |
| 5.000000E−001 | 1.268214E−002 | 1.083981E−002 | −1.842332E−003 | 3.057862E−001 |
| 1.000000E+000 | 5.078539E−002 | 4.342058E−002 | −7.364807E−003 | 3.002637E−001 |
| 1.500000E+000 | 1.144863E−001 | 9.792808E−002 | −1.655820E−002 | 2.910703E−001 |
| 2.000000E+000 | 2.040946E−001 | 1.746779E−001 | −2.941669E−002 | 2.782118E−001 |
| 2.500000E+000 | 3.200620E−001 | 2.741246E−001 | −4.593739E−002 | 2.616911E−001 |
| 3.000000E+000 | 4.629740E−001 | 3.968762E−001 | −6.609776E−002 | 2.415307E−001 |
| 3.500000E+000 | 6.335169E−001 | 5.437132E−001 | −8.980366E−002 | 2.178248E−001 |
| 4.000000E+000 | 8.324287E−001 | 7.156161E−001 | −1.168126E−001 | 1.908159E−001 |
| 4.500000E+000 | 1.060450E+000 | 9.138016E−001 | −1.466481E−001 | 1.609804E−001 |
| 5.000000E+000 | 1.318298E+000 | 1.139773E+000 | −1.785251E−001 | 1.291034E−001 |
| 5.500000E+000 | 1.606677E+000 | 1.395386E+000 | −2.112913E−001 | 9.633725E−002 |
| 6.000000E+000 | 1.926307E+000 | 1.682949E+000 | −2.433578E−001 | 6.427072E−002 |
| 6.500000E+000 | 2.277888E+000 | 2.005352E+000 | −2.725365E−001 | 3.509203E−002 |
| 7.000000E+000 | 2.661906E+000 | 2.366269E+000 | −2.956373E−001 | 1.199118E−002 |
| 7.500000E+000 | 3.078084E+000 | 2.770456E+000 | −3.076285E−001 | 0.000000E+000 |
| 8.000000E+000 | 3.524364E+000 | 3.224222E+000 | −3.001418E−001 | 7.486676E−003 |
| 8.500000E+000 | 3.995350E+000 | 3.736214E+000 | −2.591368E−001 | 4.849168E−002 |
| 9.000000E+000 | 4.480387E+000 | 4.318811E+000 | −1.615761E−001 | 1.460524E−001 |
| 9.500000E+000 | 4.961661E+000 | 4.990838E+000 | 2.917666E−002 | 3.368052E−001 |
| 1.000000E+001 | 5.412994E+000 | 5.783548E+000 | 3.705536E−001 | 6.781821E−001 |
| 1.024836E+001 | 5.615657E+000 | 6.238567E+000 | 6.229091E−001 | 9.305376E−001 |

The listing of surface 9 sag is as follows (units are millimeters):
Semi diameter of surface 9: 9.871038E+000.
Best Fit Sphere curvature: −1.709025E−002.
Best Fit Sphere radius: −5.851288E+001.

Best Fit Sphere residual: 1.907468E−001. (rms)

| Y-coord | Sag | BFS Sag | Deviation | Remove |
|---|---|---|---|---|
| 0.000000E+000 | 0.000000E+000 | 0.000000E+000 | 0.000000E+000 | 2.611232E−001 |
| 5.000000E−001 | 1.568403E−003 | −2.136321E−003 | −3.704724E−003 | 2.574184E−001 |
| 1.000000E+000 | 6.262932E−003 | −8.545751E−003 | −1.480868E−002 | 2.463145E−001 |
| 1.500000E+000 | 1.397441E−002 | −1.922970E−002 | −3.320410E−002 | 2.279191E−001 |
| 2.000000E+000 | 2.429278E−002 | −3.419050E−002 | −5.848328E−002 | 2.026399E−001 |
| 2.500000E+000 | 3.625710E−002 | −5.343144E−002 | −8.968854E−002 | 1.714346E−001 |
| 3.000000E+000 | 4.815819E−002 | −7.695675E−002 | −1.251149E−001 | 1.360082E−001 |
| 3.500000E+000 | 5.748291E−002 | −1.047716E−001 | −1.622545E−001 | 9.886865E−002 |
| 4.000000E+000 | 6.104535E−002 | −1.368821E−001 | −1.979275E−001 | 6.319567E−002 |
| 4.500000E+000 | 5.528755E−002 | −1.732954E−001 | −2.285830E−001 | 3.254017E−002 |
| 5.000000E+000 | 3.667268E−002 | −2.140196E−001 | −2.506923E−001 | 1.043091E−002 |
| 5.500000E+000 | 2.059572E−003 | −2.590636E−001 | −2.611232E−001 | 0.000000E+000 |
| 6.000000E+000 | −5.104325E−002 | −3.084375E−001 | −2.573943E−001 | 3.728905E−003 |
| 6.500000E+000 | −1.243917E−001 | −3.621524E−001 | −2.377607E−001 | 2.336248E−002 |
| 7.000000E+000 | −2.190567E−001 | −4.202202E−001 | −2.011635E−001 | 5.995968E−002 |
| 7.500000E+000 | −3.355188E−001 | −4.826540E−001 | −1.471352E−001 | 1.139880E−001 |
| 8.000000E+000 | −4.737216E−001 | −5.494680E−001 | −7.574648E−002 | 1.853767E−001 |
| 8.500000E+000 | −6.331091E−001 | −6.206774E−001 | 1.243172E−002 | 2.735549E−001 |
| 9.000000E+000 | −8.128374E−001 | −6.962982E−001 | 1.165391E−001 | 3.776623E−001 |
| 9.500000E+000 | −1.012335E+000 | −7.763480E−001 | 2.359868E−001 | 4.971100E−001 |
| 9.871038E+000 | −1.173198E+000 | −8.386246E−001 | 3.345731E−001 | 5.956963E−001 |

The listing of surface 11 sag is as follows (units are millimeters):
Semi diameter of surface 11: 7.706994E+000.
Best Fit Sphere curvature: 2.206208E−002.
Best Fit Sphere radius: 4.532664E+001.

Best Fit Sphere residual: 1.618948E−001. (rms)

| Y-coord | Sag | BFS Sag | Deviation | Remove |
|---|---|---|---|---|
| 0.000000E+000 | 0.000000E+000 | 0.000000E+000 | 0.000000E+000 | 2.385775E−001 |
| 5.000000E−001 | 8.071462E−003 | 2.757844E−003 | −5.313618E−003 | 2.332638E−001 |
| 1.000000E+000 | 3.206145E−002 | 1.103238E−002 | −2.102907E−002 | 2.175484E−001 |
| 1.500000E+000 | 7.124356E−002 | 2.482664E−002 | −4.641692E−002 | 1.921605E−001 |
| 2.000000E+000 | 1.242243E−001 | 4.414566E−002 | −8.007861E−002 | 1.584988E−001 |
| 2.500000E+000 | 1.886616E−001 | 6.899651E−002 | −1.196651E−001 | 1.189124E−001 |
| 3.000000E+000 | 2.608960E−001 | 9.938833E−002 | −1.615077E−001 | 7.706979E−002 |
| 3.500000E+000 | 3.355963E−001 | 1.353323E−001 | −2.002640E−001 | 3.831347E−002 |
| 4.000000E+000 | 4.056332E−001 | 1.768416E−001 | −2.287916E−001 | 9.785864E−003 |
| 4.500000E+000 | 4.625092E−001 | 2.239317E−001 | −2.385775E−001 | 0.000000E+000 |
| 5.000000E+000 | 4.977356E−001 | 2.766201E−001 | −2.211156E−001 | 1.746189E−002 |
| 5.500000E+000 | 5.054698E−001 | 3.349264E−001 | −1.705434E−001 | 6.803404E−002 |
| 6.000000E+000 | 4.863506E−001 | 3.988725E−001 | −8.747809E−002 | 1.510994E−001 |
| 6.500000E+000 | 4.516047E−001 | 4.684825E−001 | 1.687777E−002 | 2.554552E−001 |
| 7.000000E+000 | 4.248088E−001 | 5.437828E−001 | 1.189741E−001 | 3.575515E−001 |
| 7.500000E+000 | 4.357239E−001 | 6.248023E−001 | 1.890784E−001 | 4.276558E−001 |
| 7.706994E+000 | 4.557005E−001 | 6.600245E−001 | 2.043240E−001 | 4.429014E−001 |

The listing of surface 13 sag is as follows (units are millimeters):
Semi diameter of surface 13: 6.945534E+000.
Best Fit Sphere curvature: 2.000000E-−002.
Best Fit Sphere radius: 5.000000E+001.

Best Fit Sphere residual: 2.041468E−012. (rms)

| Y-coord | Sag | BFS Sag | Deviation | Remove |
|---|---|---|---|---|
| 0.000000E+000 | 0.000000E+000 | 0.000000E+000 | 0.000000E+000 | 3.496148E−012 |
| 5.000000E−001 | 2.500063E−003 | 2.500063E−003 | −1.785724E−014 | 3.478291E−012 |
| 1.000000E+000 | 1.000100E−002 | 1.000100E−002 | −7.144459E−014 | 3.424703E−012 |
| 1.500000E+000 | 2.250506E−002 | 2.250506E−002 | −1.608054E−013 | 3.335342E−012 |
| 2.000000E+000 | 4.001601E−002 | 4.001601E−002 | −2.860281E−013 | 3.210120E−012 |
| 2.500000E+000 | 6.253911E−002 | 6.253911E−002 | −4.472256E−013 | 3.048922E−012 |
| 3.000000E+000 | 9.008115E−002 | 9.008115E−002 | −6.445400E−013 | 2.851608E−012 |
| 3.500000E+000 | 1.226504E−001 | 1.226504E−001 | −8.781448E−013 | 2.618003E−012 |
| 4.000000E+000 | 1.602568E−001 | 1.602568E−001 | −1.148248E−012 | 2.347900E−012 |
| 4.500000E+000 | 2.029117E−001 | 2.029117E−001 | −1.455142E−012 | 2.041006E−012 |
| 5.000000E+000 | 2.506281E−001 | 2.506281E−001 | −1.799061E−012 | 1.697087E−012 |
| 5.500000E+000 | 3.034206E−001 | 3.034206E−001 | −2.180311E−012 | 1.315836E−012 |
| 6.000000E+000 | 3.613054E−001 | 3.613054E−001 | −2.599310E−012 | 8.968382E−013 |
| 6.500000E+000 | 4.243003E−001 | 4.243003E−001 | −3.056333E−012 | 4.398149E−013 |
| 6.945534E+000 | 4.847543E−001 | 4.847543E−001 | −3.496148E−012 | 0.000000E+000 |

To obtain the desired acceptable optical convergence of display panels 14A and 14B at distance D₂ on center axis 100, the positions of displays 14A and 14B should be properly positioned or aligned relative to the lens assemblies 20A and 20B and center axis 100. When a binocular display device 10 is initially assembled, the display panels 14A and 14B are typically not in acceptable positions. Adjusting the positions of the display panels 14A and 14B by eye can be slow and difficult, with inconsistent results.

A particular alignment system is therefore desired that can be used to more quickly, easily, and consistently optically aligning the displays 14A and 14B of a binocular display device 10 as well as other binocular display devices, in acceptable locations for suitable binocular viewing. Discussion of the alignment of one possible binocular display device 10 now follows.

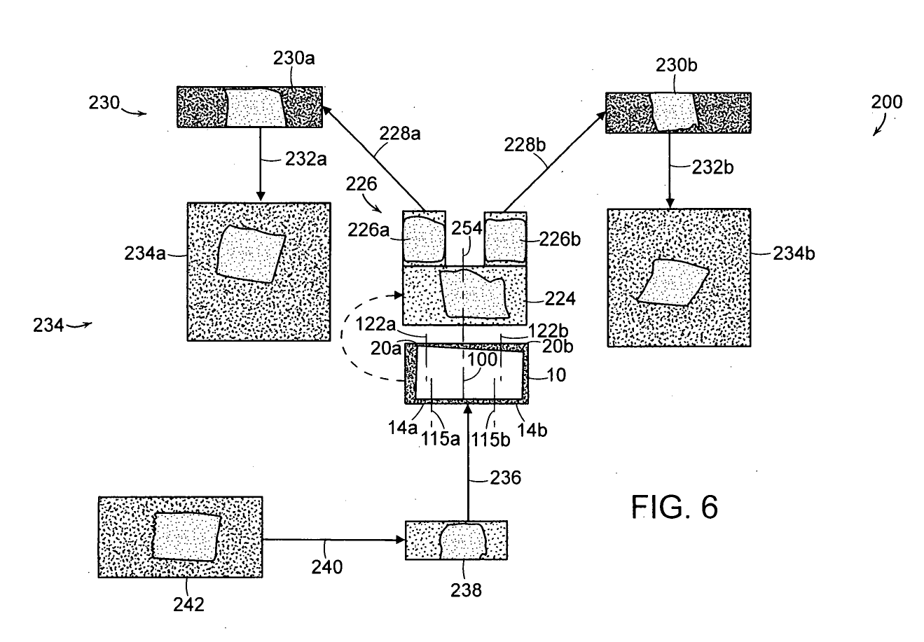

FIG. 6 is a schematic drawing of an embodiment of a binocular display device alignment system. The alignment system 200 can include a mounting fixture 224 to which the binocular display device 10 can be secured in a fixed position during the alignment process, for example, by clamping or other suitable methods. A camera system 226 can be included for looking through the right 20A and left 20B lens assemblies for viewing, observing or recording respective right 14A and left 14B display panels. In one embodiment, the camera system 226 can include a first (or right) camera 226A, and a second (or left) camera 226B, which are mounted or fixed to the mounting fixture 224. The right camera 226A can view, observe or record the right 14A display panel through the right 20A lens assembly and the left camera 226B can view, observe or record the left 14B display panel through the left 20B lens assembly.

Once the binocular display device 10 is secured to the mounting fixture 224, a display panel indicia source 242 can be electrically connected to the binocular display device 10, such as at the circuit board 30, for providing the right 14A and left 14B display panels with display alignment indicia 251. In one embodiment, the display alignment indicia 251 can be a crosshair having vertical 247 and horizontal lines 249, which is centered along the central optical axis 115 of the display panels 14A and 14B, for example, as seen on the right display panel 14A shown in FIG. 7. The display alignment indicia 251 can appear in similar fashion on the left display panel 14B.

Referring back to FIG. 6, images of the right 14A and left 14B display panels as seen by camera system 226, are displayed or projected on a viewing screen system 234. As a result, the display alignment indicia 251 on the right 14A and left 14B display panels are also displayed on the viewing screen system 234. In one embodiment, the viewing screen system 234 can have a first or right viewing screen 234A and a second or left viewing screen 234B. The right viewing screen 234A is in communication with the right camera 226A for viewing images of the display alignment indicia 251 on the right display panel 14A, and the left viewing screen 234B is in communication with the left camera 226B for viewing images of the display alignment indicia 251 on the left display panel 14B. The viewing screen system 234 can be also provided with baseline indicia 252, from a viewing screen indicia source system 230. In one embodiment, the baseline indicia 252 can be a crosshair having vertical 246 and horizontal lines 248 which cross at an intersection or center 250.

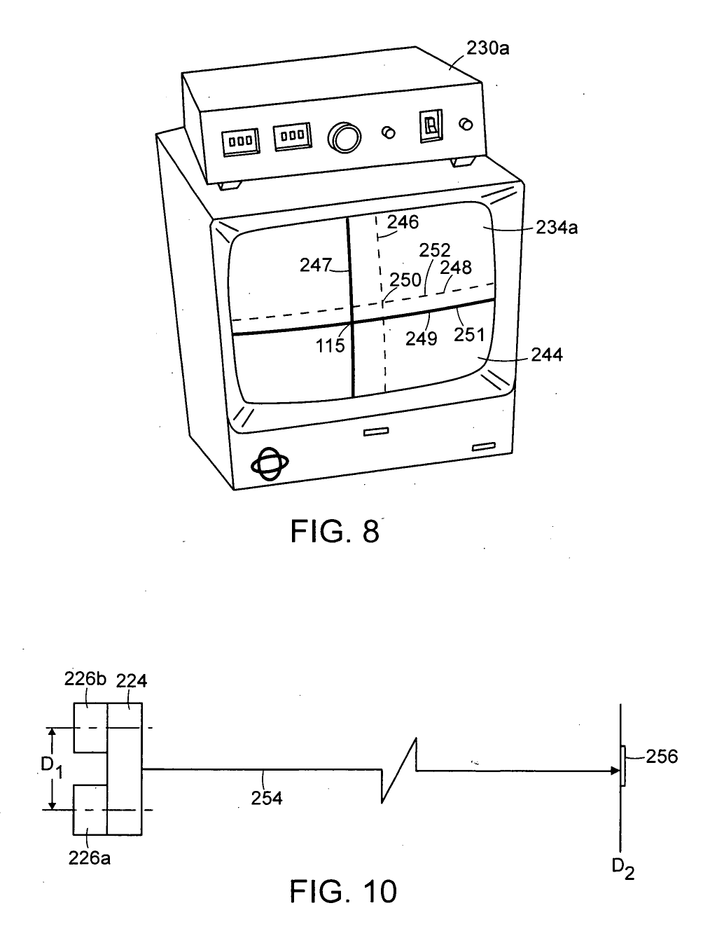

An example of what is shown on the viewing screens 234A and 234B can be seen in FIG. 8 which depicts an embodiment of the right viewing screen 234A. The viewing screen indicia source system 230 can have a first or right indicia source 230A and second or left indicia source 230B which are associated with and connected to respective viewing screens 234A and 234B. Baseline indicia 252 can be provided to the right viewing screen 234A by the right indicia source 230A and to the left viewing screen 234B by the left indicia source 230B.

Referring to FIG. 8, during alignment, the screen 244 of viewing screen 234A can display both the display panel alignment indicia 251 on display panel 14A and the baseline indicia 252. The baseline indicia 252 can be positioned at a predetermined or precalibrated location on the screen 244 of viewing screen 234A for the alignment process. The display panel 14A on the binocular display device 10 can then be adjusted to move the display panel alignment indicia 251 in alignment with the baseline indicia 252 on the viewing screen 234A. Once the alignment is made, the display panel 14A is then positioned in the proper location relative to the binocular display device 10 for suitable binocular viewing. The display panel 14A can be moved vertically and horizontally by adjusting the vertical 9 and horizontal 11 adjustment frames of the binocular display device 10 (FIG. 2).

The process for aligning display panel 14B is similar, where the display panel alignment indicia 251 for display panel 14B can be moved in alignment with the baseline indicia 252 on viewing screen 234B with movement or adjustment of the display panel 14B on the binocular display device 10. The display panels 14A and 14B can be adjusted in a symmetrical manner.

Typically, the display panels 14A and 14B are moved until the crosshair of the display alignment indicia 251 on the screen 244 is aligned or superimposed over the baseline indicia 252 so that the central optical axis 115 of the display panels 14A and 14B is positioned at the center 250 of the baseline indicia 252. Such adjusting of the display panels 14A and 14B can be performed manually or can be automated, for example, by suitable machinery, robots, etc. If the indicia 251 and 252 cannot be superimposed over each other, it can be acceptable for the indicia 251 and 252 to be positioned close to each other in a symmetrical manner and within a tolerance range. It is possible that, on occasion, a display panel 14A or 14B might not require any adjusting, or might only require adjustment in one direction. Once adjusted, the display panels 14A and 14B can be locked in place with adhesives or by other suitable means.

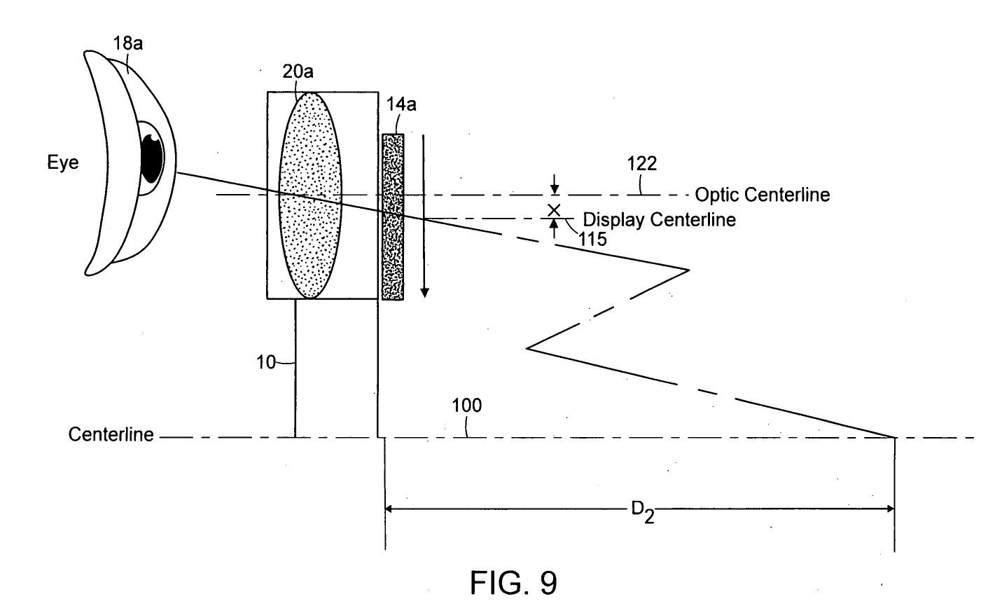

Referring to FIG. 9, the optical axes 122 of lens assemblies 20A and 20B can be positioned or lie on the same horizontal level or plane as the optical axes 115 of the display panels 14A and 14B. However, the optical axes 115 of the display panels 14A and 14B are typically positioned laterally offset from the optical axis 122 of the lens assemblies 20A and 20B towards the central longitudinal axis 100 by a distance X.

Referring to FIG. 10, the cameras 226A and 226B (FIG. 6) can be mounted to the mounting fixture 224 in a manner where the cameras 226A and 226B are positioned on opposite sides of a central longitudinal axes 254 and extend or lie along a common horizontal plane. The cameras 226A and 226B can be mounted parallel to each other, or in some embodiments, slightly angled towards each other. The cameras 226A and 226B can be spaced apart from each other between centers by about the same distance D₁ as the lens assemblies 20A and 20B, or within an acceptable tolerance. In addition, the central longitudinal axis 254 of the mounting fixture 224 can coincide with the central axis 100 of the binocular display device 10 when secured to the mounting fixture 224. Therefore, cameras 226A and 226B can optically coincide or be aligned with the optical axes 122 of the lens assemblies 20A and 20B of the binocular display device 10 when secured to the mounting fixture 224.

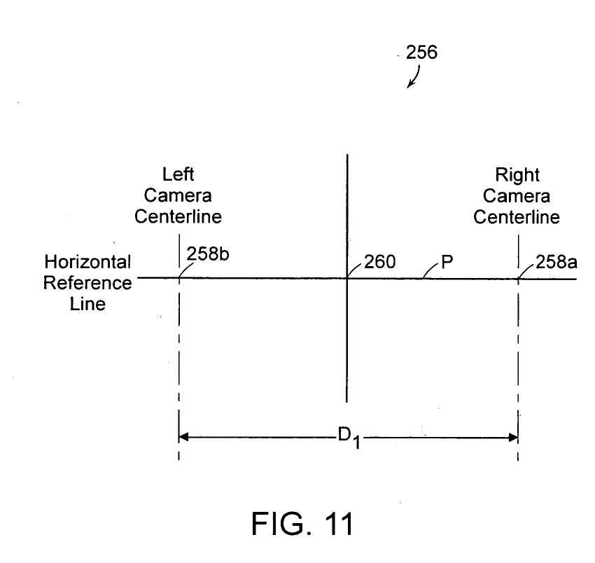

The cameras 226A and 226B can be prefocused or precalibrated on a reference target 256 (FIG. 11) at a location on central longitudinal axis 254 at a distance D₂. The reference target 256 can include a first or right crosshair 258A and a second or left crosshair 258B which can be positioned apart by a distance D₁ on a horizontal plane P for alignment with respective cameras 226A and 226B. A central crosshair 260 can be positioned between crosshairs 258A and 258B on horizontal plane P for alignment with axis 254. The cameras 226A and 226B can be prefocused on the respective crosshairs 258A and 258B. The prefocusing of the cameras 226A and 226B allows the cameras 226A and 226B to focus on the display panels 14A and 14B when viewed through the lens assemblies 20A and 20B of the binocular display device 10. The distance D₂ appears to be the same as that when viewing the display panels 14A and 14B through the lens assemblies 20A and 20B of the binocular display device 10. In one embodiment, the distance D₁ between cameras 226A and 226B between centers can be 63.5 mm to coincide with a binocular display device 10 having lens assemblies 20A and 20B with optical axes 22 that are spaced apart by a distance D₁ of 63.5 mm interpupillary distance (IPD) standard.

The position or location of the baseline indicia 252 on each screen 234A and 234B can be precalibrated to be at a suitable position for the alignment process. This can be accomplished by projecting the images of the crosshairs 258A and 258B of the reference target 256 as viewed by the cameras 226A and 226B onto the viewing screens 234A and 234B. The baseline indicia 252 can then be projected on each viewing screen 234A and 234B. The positions of the baseline indicia 252 on each viewing screen can be adjusted by adjusting controls on the viewing screen indicia sources 230A and 230B until the baseline indicia 252 are superimposed over the images of the crosshairs 258A and 258B on each viewing screen 230A and 230B. The baseline indicia 252 are then in calibrated positions on each viewing screen 230A and 230B.

An alternative method of precalibration can be accomplished by securing a binocular display device 10 to the mounting fixture 224 that already has the display panels 14A and 14B in suitable alignment. The display panel indicia source 242 can then be connected in communication with the binocular display device 10 and display panel alignment indicia 251 is projected onto the display panels 14A and 14B in a centered manner. The baseline indicia 252 can be projected on each viewing screen 234A and 234B and the position of the baseline indicia 252 can be moved by adjusting the controls on the viewing screen indicia sources 230A and 230B until the baseline indicia 252 are superimposed over the display panel alignment indicia 251 on each viewing screen 230A and 230B.

In one embodiment, the display panel indicia source 242 can be a video source which can be connected in communication with the binocular display device 10 by a cable 240, a video converter 238, and a cable 236. The cable 240 can be a video cable, the video converter 238 can convert VGA to NTSC, and cable 236 can be a BDM cable. The cameras 226A and 226B of the camera system 226 can be CCD cameras, and can have a 12V DC/500 mA regulated power supply and a 12.0 mm FL micro video lens. The cameras 226A and 226B can be connected in communication with the viewing screen indicia sources 230A and 230B by connectors 228A and 228B, for example, BNC male to NTSC male connectors. The viewing screen indicia sources 230A and 230B can be TG100 single camera adjustable video target generators with a thumbwheel position control. The viewing screens 234A and 234B can be connected in communication with respective viewing screen indicia sources 230A and 230B with cables respective 232A and 232B, such as BNC male to BNC male cables. The viewing screens 234A and 234B can be 12 inch monochrome monitors with EIA/CCIR auto-sensing.

Although a particular display panel indicia source 242 and viewing screen indicia source system 230 have been described, it is understood that other suitable devices for producing indicia can be employed. Although the display panel alignment indicia 251 and the baseline indicia 252 are shown in one embodiment to be crosshairs that are superimposed during the alignment process, it is understood that the indicia 251 and 252 can be of many different configurations. For example, the indicia 251 and 252 can be other geometric indicia, for example, circles, squares, polygons, etc., or can be complex images, patterns, configurations, icons, etc., which are aligned. In addition, the indicia 251 and 252 do not have to be identical or superimposed, for example, one can represent a target, puzzle, half an image, etc., and the other can represent the dart, missing piece of the puzzle, the other half of the image, etc., which are positioned in the appropriate location for alignment purposes. Also, one or both of the display alignment indicia 251 and 252 do not have to be electronically generated on the display panels 14A and 14B, or the viewing screens 234A and 234B. For example, one or both of the indicia 251 and 252 can be physically added to the display panels 14A and 14B or viewing screens 234A and 234B, or can be physical characteristics, such as an edge, outline, particular feature, etc. With differing indicia 251 and the configuration of the reference target 256 can vary.

Although the display panels 14A and 14B are shown to have a single unitary screen, the display panels 14A and 14B can include multiple screens joined together to form a composite display panel. Additionally, in some embodiments, the mounting fixture 224 can be on a mechanism such as a robotic arm, or a robotic gripper can serve as the mounting fixture 224 for positioning the lens assemblies 20A and 20B of the binocular display device 10 in alignment with the camera system 226.

Although in one embodiment the cameras 226A and 226B are mounted to the mounting fixture 224, alternatively, the cameras 226A and 226B can be mounted relative to the mounting fixture 224 without being mounted directly to the mounting fixture 224. Although FIG. 6 depicts screen viewing system 234 with two viewing screens 234A and 234B, the viewing screen system 234 can have only one viewing screen. In such a case, the screen 244 can be split for displaying and aligning both display panels 14A and 14B on the same screen 244. In other embodiments, the single viewing screen can show and align only one display panel 14A or 14B at a time, but can be switched between one or the other. A single viewing screen indicia source 230 is also contemplated for generating two separate baseline indicia 252 for aligning both displays 14A and 14B. Also, the camera system 226 can include only one camera. In such a case, the camera can have optics for viewing through both lens assemblies 20A and 20B either simultaneously or sequentially, or a mechanism can be employed for sequentially aligning the camera relative to the lens assemblies 20A and 20B. Although FIG. 6 depicts electrical connections between the various components such as by cables and connectors, if desired, wireless communication between selected components can be made.

Although embodiments of the disclosed alignment system have been shown and described to align the display panels 14A and 14B of the binocular display device 10 depicted in FIGS. 1-3, it is understood that the alignment of display panels in a number of different binocular display devices is contemplated. In addition, embodiments of the alignment system can be used for aligning displays in other devices including projection devices, projection televisions, non-binocular viewing devices, etc.

Returning to FIGS. 1-3, by integrating the electronics circuit board 30 is integrated into the unit, a self-contained solution is achieved that could be easily incorporated into a HMD product. The unit provides an optimized optical solution that is pre-aligned and has the electronics built in. The customer designing a HMD need only provide a selected video signal and power to the BDM 10.

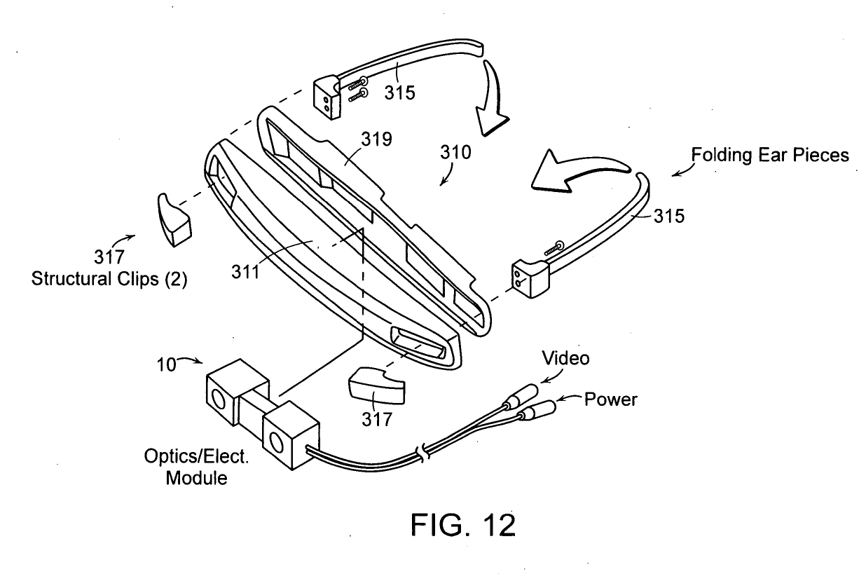

FIG. 12 is a perspective view of a particular embodiment of a head-mounted display device incorporating the binocular display module of FIG. 1. The particular embodiment shown is an ultra-light implementation. This unit includes a thin wall vacuum formed or injection molded head-mountable housing 310 comprised of a front section 311 and a back section 319. Folding earpieces 315 are attached through the housing into structural clips 317 located into the front housing section 311 and secured by screws. These clips 317 could be also molded into the front housing section 311. The BDM 10 is sandwiched between the front and back. If the HMD 310 includes audio capabilities, audio cables can also be connected to the module structure. The HMD 310 can be worn in a manner that is similar to wearing a pair of eyeglasses.

In some embodiments, only a single LCD display 14 may be positioned within the HMD housing 310. The displayed image on a single LCD display 14 can be binocularly viewed by the wearer, or a single display device can be worn as a monocular display. A user 300 can also wear the HMD 310 while also wearing eyeglasses 350.

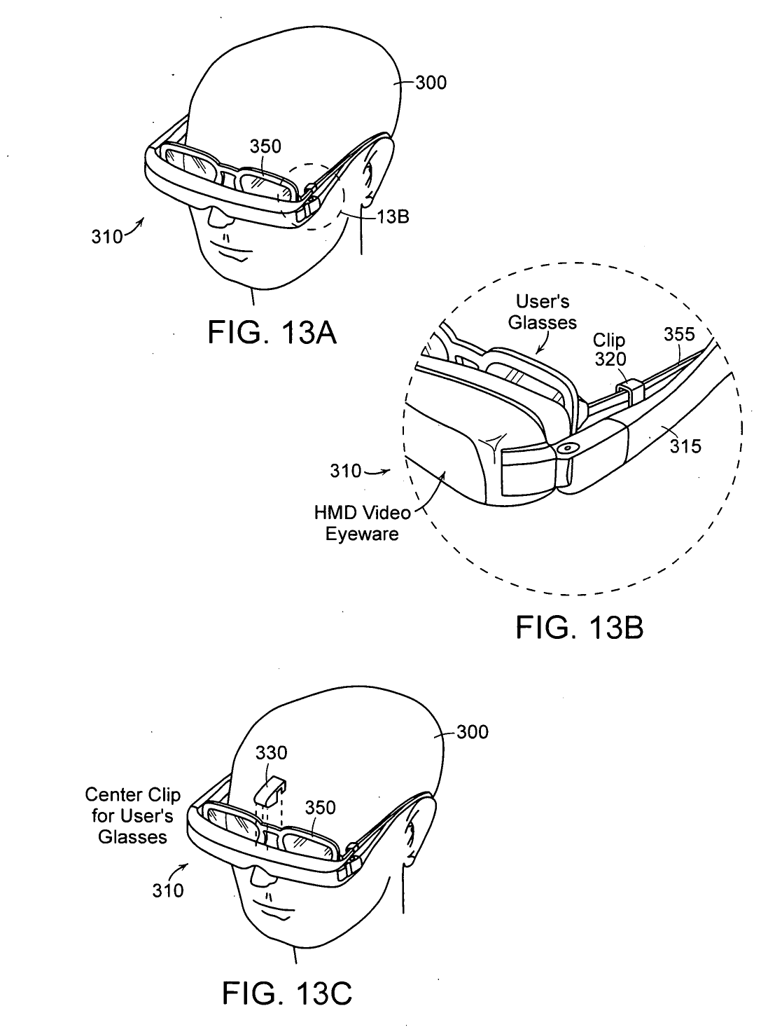

FIGS. 13A-13C are perspective views of a user wearing a particular head mounted display while also wearing eyeglasses. The earpiece stems 315 includes side support clip members 320, which can rest on and engage the stems 355 of the eyeglasses 350 for supporting the HMD 310 on the stems 355 of the eyeglasses 350. The clips 320 can be retractable, for example, laterally, vertically, at an angle, along an arc, etc., so that if a user 300 is not wearing eyeglasses 350, the clips 320 can be retracted. If desired, the clips 320 can also be detachable.

The HMD 310 can also have a front center support clip member 330 for resting on and engaging the top central region of the frame of the eyeglasses 350 for further supporting the HMD 310 on the eyeglasses 350. If desired, the clip 330 can extend most or all of the length of the frame of the eyeglasses 350, or multiple clips 330 can be employed. Clips 320 can also be configured in a similar manner. Clips 320 and/or clip 330 can provide resilient gripping, and can provide proper alignment of the display 310 laterally or along the viewing axis.

The display 310 can also have a nose bridge piece or support member. The nose bridge can be retracted when the user is wearing eyeglasses to accommodate the eyeglasses, or deployed if the user is not wearing eyeglasses.

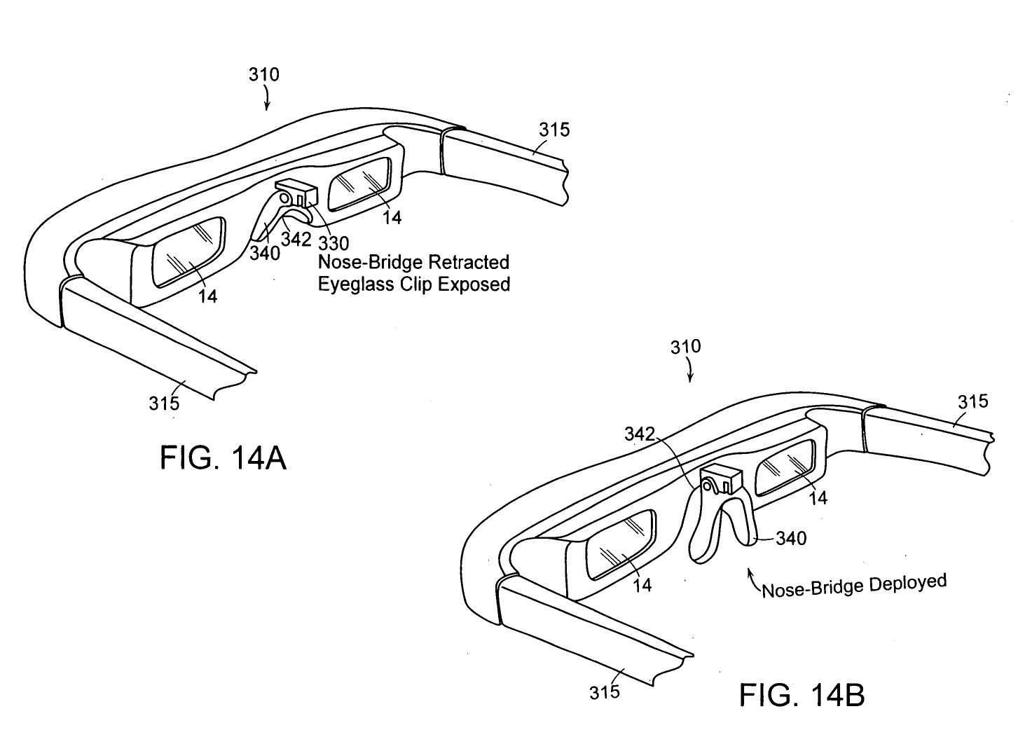

Referring to FIG. 14, the nose bridge 340 can be pivoted about a pivot 342. The pivoting action of the nose bridge 340 can be spring loaded and/or can have locking capabilities. The nose bridge 340 can be attached to the clip 330 and can expose the clip 330 for use when retracted, or cover the clip 330 when deployed. The clip 330 can include a notch, groove, recess, etc., which can engage the top of the eyeglasses 350.

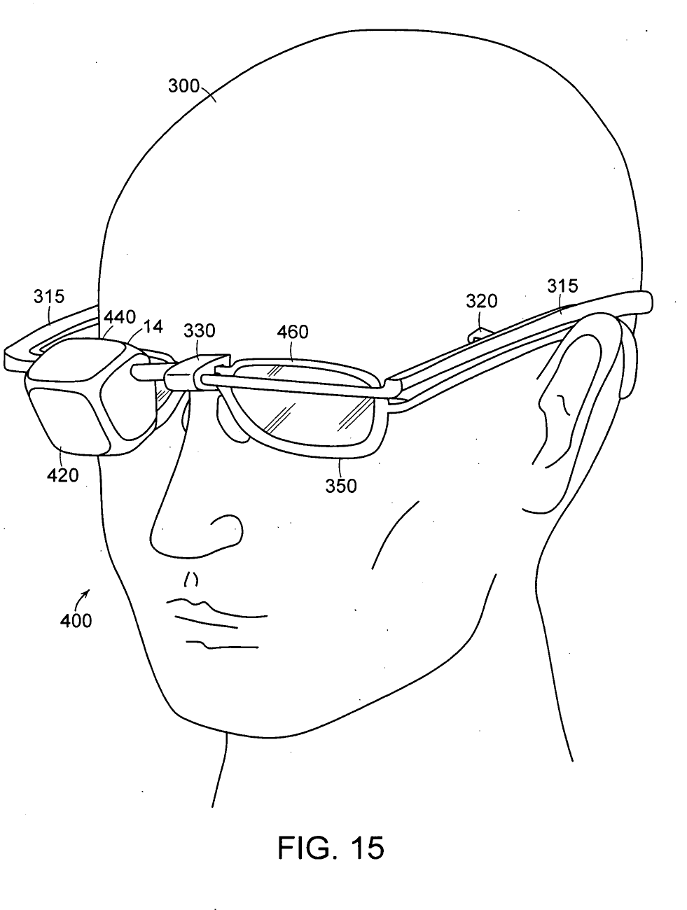

FIG. 15 depicts an embodiment of a monocular display 400, which differs from the HMD 310 as depicted in FIGS. 12-14, in that the monocular display 400 includes a housing 420 containing an optics/electrical module 440 having a single LCD display 14. The housing 420 is sized and positioned to be in front of only one eye of the user 300 so that the other eye is not obstructed. The housing 420, clip 330 and nose bridge 340 can be mounted to a cross member 460, which extends between the earpiece stems 315. The LCD display 14 can be supported by eyeglasses 350 and positioned in front of the right eye as shown, or alternatively, the left eye.

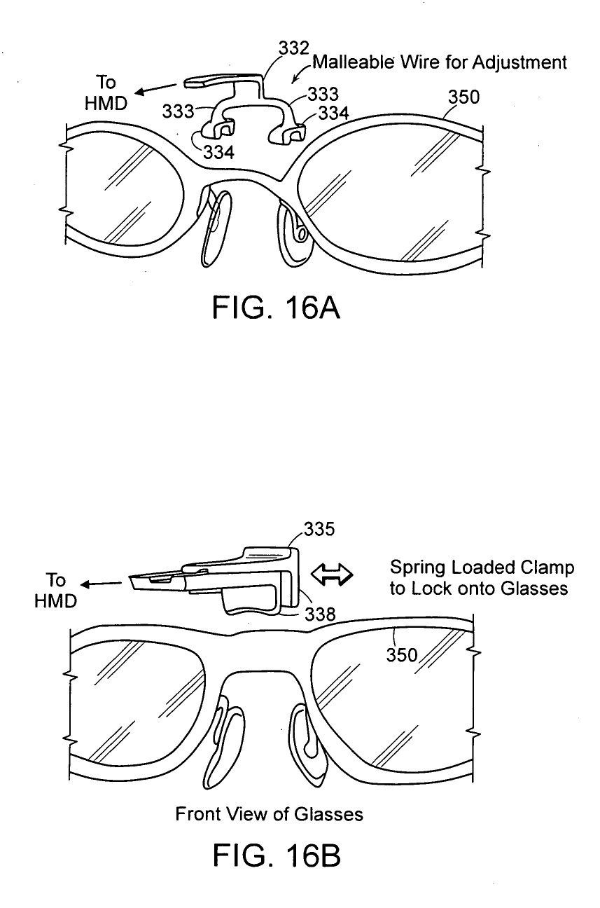

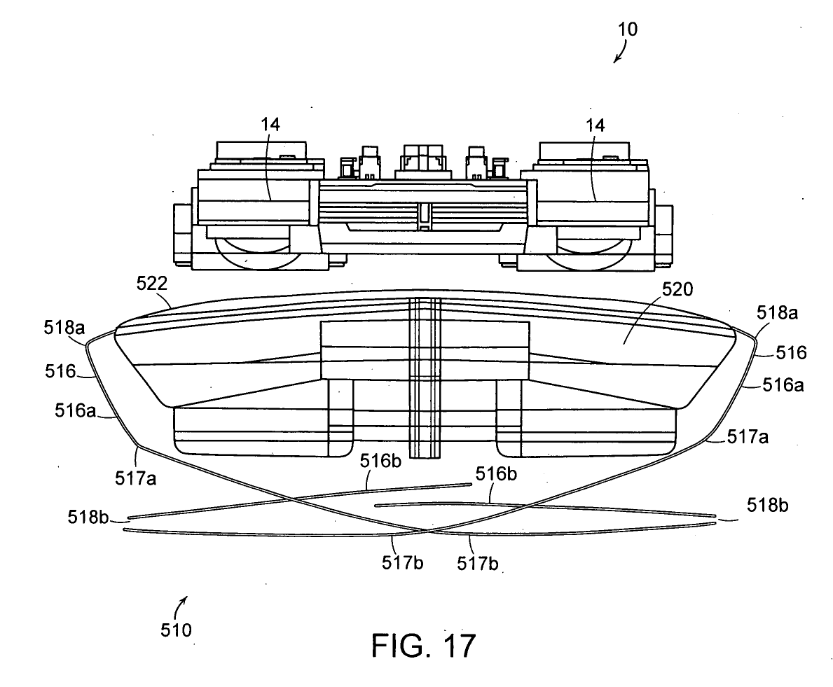

FIGS. 16A-16B depict other embodiments of front center support clip members. As shown in FIG. 16A, a front center support clip member 332 can be made of bendable or deformable material, such as wire, to allow adjustment. The clip 332 can include two arms 333, each having a notched end 334 for resting on and engaging the top of the frame of the eyeglasses 350 in the region of the bridge.

In another embodiment, as shown in FIG. 16B, a front center support clip member 335 can include a spring loaded clamp for engaging and locking onto the top of the frame of the eyeglasses 350 in the region of the bridge. The clip 335 is shown with opposed jaws 338 which clamp in the lateral direction. Alternatively, clip 335 can clamp in other suitable directions, along an arc, or in a cam like arrangement. It is contemplated that center support clip members having other configurations can also be employed.

It should also be understood that the earpiece stems of the HMD's do not have to fold and can be formed integrally with the housing. In some embodiments of the displays that may be worn with eyeglasses, the earpiece stems can be truncated or omitted. In such embodiments, the displays can include additional clip members, clamps, set screws, etc. in other locations for engaging the eyeglasses for stability. In some embodiments, the eyeglasses can be secured within the housing of the displays. Clips or securing members can also be positioned on the bottom of the eyeglasses to aid in securement. The eyeglasses can also include attachment devices, arrangements or features incorporated into the frames, for example holes, threaded holes, pins, locking tabs or receptacles, etc., to which mating fastening devices, arrangements or features on the displays can engage for locking the displays to the eyeglasses. The BDM 10 can also be fabricated so as to be directly coupled to earpieces.

FIG. 17 is a top view of an embodiment of a head mounted display with the earpiece stems folded. As shown, two earpiece members or stems 516 can be secured to the BDM housing 520, allowing the structure to be worn in a manner that is similar to wearing a pair of eyeglasses. A particular structure is commercially available from Kopin Corporation of Taunton, Mass. under part number KCD-QDNF-BA.

The housing 520 can have contours 521 on the front surface, which provide an appearance similar to eyeglass lenses. A ridge 526 can extend on the front surface. A nose bridge 528 can be included for resting on the user's 524 nose. A connecting rib, piece or member 522 can extend across the front of the housing 520 and connect to the earpiece stems 516. The connecting member 522 can be secured to the housing 520 or can be integrally formed or molded into the housing 520.

The earpiece stems 516 can include more than one folding joint, for example, first and second folding joints 518a and 518b, as shown, and more than one stem segment, for example, first and second stem segments 516a and 516b, as shown. The first folding joints 518a can pivotably or foldably connect the earpiece stems 516 to the connecting member 522. The second folding joints 518b can be positioned at an intermediate location on each earpiece stem 516 and can pivotably or foldably connect stem segments 516a and 516b to each other. The first folding joint 518a can allow the first segment 516a of each earpiece stem 516 to fold behind the rear of the housing 520. The second folding joint 518b can allow the second segment 516b to be folded relative to the first segment 516a, thereby reducing the length or size of the earpiece stem 516. The joints 518a and 518b can fold or rotate within a predetermined and fixed arc or angle, and can have locking mechanisms.

The earpiece stems 516 can also include one or more bends, for example, bends 517a and 517b, as shown. The bends 517a and 517b can be shaped to allow the earpiece stems 516 to be folded around the rear of the housing 520 more closely as well as for comfort. The folding joints 518a and 518b can fold in an inwardly manner and, in combination with the bands 517a and 517b, can allow the segments 516a and 516b to be folded closely to the housing 520 in a compact manner for storage. In particular, the resulting assembly can fit in the palm of a user's hand when folded, and can be of a size comparable to a pair of eyeglasses. In some embodiments, each earpiece stem can have more than two joints and two segments.

While this invention has been particularly shown and described with references to particular embodiments, it will be understood by those skilled in the art that various changes in form and details may be made without departing from the scope of the invention.

What is claimed is:

1. A binocular display device, comprising:
a frame;
a first display panel mounted to the frame for forming a first image having a first display axis;
a second display panel mounted to the frame for forming a second image having a second display axis;
a first lens assembly mounted to the frame and having a first viewing axis;
a second lens assembly mounted to the frame and having a second viewing axis;
a first alignment fixture for aligning the first display axis relative to the first viewing axis;
a second alignment fixture for aligning the second display axis relative to the second viewing axis;
a fastener for fixing the first and second alignment fixtures in the respective alignment so that the first and second images are registered when binocularly viewed by a viewer through the first and second lens assemblies.

2. The display device of claim 1 wherein the display panels are liquid crystal display panels.

3. The display device of claim 1 further comprising at least one backlight to illuminate the display panels.

4. The display device of claim 1 further comprising an interface circuit coupled to the display panels to provide power and a data signal.

5. The display device of claim 1 wherein the alignment fixtures allow for vertical and horizontal adjustment of the display panels relative to the frame.

6. The display device of claim 1 wherein the fastener is an adhesive.

7. The display device of claim 1 further comprising a first earpiece and a second earpiece for mounting the frame to a viewer's head.

8. The display device of claim 7 wherein the earpieces include a respective hinge disposed along the longitudinal length of each earpiece.

9. The display device of claim 7 further comprising eyeglass mounts to facilitate mounting of the frame to eyeglasses.

10. The display device of claim 9 wherein the eyeglass mounts include a retractable nose bridge.

11. An alignment system for aligning first and second display panels of a binocular display device, the binocular display device having a first lens assembly for viewing the first display panel and a second lens assembly for viewing the second display panel, the alignment system comprising:
a camera system for viewing the first display panel of the binocular display device through the first lens assembly, and the second display panel through the second lens assembly;
display panel alignment indicia located on the first and second display panels; and
a viewing screen system for viewing images of the display panel alignment indicia on the first and second display panels which are provided by the camera system, the viewing screen system including baseline indicia, whereby the first and second display panels can be adjusted into an alignment position for binocular viewing by adjusting positions of the display panels until the images of the display panel indicia shown on the viewing screen system are located relative to the baseline indicia in a manner that indicates acceptable alignment.

12. The alignment system of claim 11 further comprising a mounting fixture for securing the binocular display device in a fixed position.

13. The alignment system of claim 12 further comprising a display panel indicia source for providing the first and second display panels with the display panel alignment indicia.

14. The alignment system of claim 13 further comprising a viewing screen indicia source system for providing the viewing screen system with the baseline indicia.

15. The alignment system of claim 14 in which the display panel alignment indicia and baseline indicia each comprises a crosshair for alignment with each other.

16. The alignment system of claim 12 in which the camera system comprises a first camera for viewing the first display panel and a second camera for viewing the second display panel.

17. The alignment system of claim 16 in which the first and second cameras are mounted relative to the mounting fixture.

18. The alignment system of claim 17 in which the first and second lens assemblies of the binocular display device each have an optical axis which are spaced apart from each other by a distance D₁, the first and second cameras being spaced apart from each other about the same distance D₁ for alignment with respective first and second lens assemblies.

19. The alignment system of claim 18 in which the first and second cameras are positioned on opposite sides of a longitudinal axis, the first and second cameras being prefocused on a location on the longitudinal axis at a distance D₂ which allows the cameras to focus on the first and second display panels when viewed through the first and second lens assemblies of the binocular display device.

20. The alignment system of claim 17 in which the viewing screen system comprises first and second viewing screens, the first viewing screen capable of viewing images seen by the first camera and the second viewing screen capable of viewing images seen by the second camera.

21. An alignment system for aligning first and second display panels of a binocular display device, the binocular display device having a first lens assembly for viewing the first display panel and a second lens assembly for viewing the second display panel, the alignment system comprising:
a mounting fixture for securing the binocular display device in a fixed position;
a camera system positioned relative to the mounting fixture for viewing the first display panel of the binocular display device with a first camera through the first lens assembly, and for viewing the second display panel with a second camera through the second lens assembly;
display panel alignment indicia located on the first and second display panels;
a display panel indicia source for providing the first and second display panels with the display panel alignment indicia;
a viewing screen system for viewing images of the display panel alignment indicia on the first and second display panels which are provided by the camera system; and
a viewing screen indicia source system for providing the viewing screen system with baseline indicia, whereby the first and second display panels can be adjusted into an alignment position for binocular viewing by adjusting positions of the display panels until the images of the display panel indicia shown on the viewing screen system are located relative to the baseline indicia in a manner that indicates acceptable alignment.

22. The alignment system of claim 21 in which display panel alignment indicia and baseline indicia each comprise a crosshair for alignment with each other.

23. The alignment system of claim 21 in which the first and second lens assemblies of the binocular display device each have an optical axis which are spaced apart from each other by a distance D₁, the first and second cameras being spaced apart from each other about the same distance D₁ for alignment with respective first and second lens assemblies.

24. The alignment system of claim 23 in which the first and second cameras are positioned on opposite sides of a longitudinal axis, the first and second cameras being prefocused on a location on the longitudinal axis at a distance D₂ which allows the cameras to focus on the first and second display panels when viewed through the first and second lens assemblies of the binocular display device.

25. The alignment system of claim 21 in which the viewing screen system comprises first and second viewing screens, the first viewing screen capable of viewing images seen by the first camera and the second viewing screen capable of viewing images seen by the second camera.

26. An alignment system for aligning first and second display panels of a binocular display device, the binocular display device having a first lens assembly for viewing the first display panel and a second lens assembly for viewing the second display panel, the alignment system comprising:
means for observing the first display panel of the binocular display device through the first lens assembly, and the second display panel through the second lens assembly;
display panel alignment indicia located on the first and second display panels; and
means for viewing images of the display panel alignment indicia on the first and second display panels which are provided by the observing means, the viewing means including baseline indicia, whereby the first and second display panels can be adjusted into an alignment position for binocular viewing by adjusting positions of the display panels until the images of the display panel indicia shown on the viewing means are located relative to the baseline indicia in a manner that indicates acceptable alignment.

27. A method of aligning first and second display panels of a binocular display device, the binocular display device having a first lens assembly for viewing the first display panel and a second lens assembly for viewing the second display panel, the method comprising:
with a camera system, viewing the first display panel of the binocular display device through the first lens assembly, and viewing the second display panel through the second lens assembly;
providing display panel alignment indicia on the first and second display panels;
with a viewing screen system, viewing images of the display panel alignment indicia on the first and second display panels which are provided by the camera system, the viewing screen system including baseline indicia; and
adjusting the first and second display panels into an alignment position for binocular viewing by adjusting positions of the display panels until the images of the display panel indicia shown on the viewing screen system are located relative to the baseline indicia in a manner that indicates acceptable alignment.

28. The method of claim 27 further comprising securing the binocular display device in a fixed position with a mounting fixture.

29. The method of claim 28 further comprising providing the first and second display panels with the display panel alignment indicia from a display panel indicia source.

30. The method of claim 29 further comprising providing the viewing screen system with the baseline indicia from a viewing screen indicia source system.

31. The method of claim 30 further comprising displaying each display panel alignment indicia and baseline indicia as a crosshair for alignment with each other.

32. The method of claim 27 further comprising:
viewing the first display panel with a first camera of the camera system; and
viewing the second display panel with a second camera of the camera system.

33. The method of claim 32 further comprising mounting the first and second cameras relative to the mounting fixture.

34. The method of claim 33 in which the first and second lens assemblies of the binocular display device each have an optical axis which are spaced apart from each other by a distance D₁, the method further comprising spacing the first and second cameras apart from each other about the same distance D₁ for alignment with respective first and second lens assemblies.

35. The method of claim 34 further comprising:
positioning the first and second cameras on opposite sides of a longitudinal axis; and
prefocusing the first and second cameras on a location on the longitudinal axis at a distance D₂ in order to allow the cameras to focus on the first and second display panels when viewed through the first and second lens assemblies of the binocular display device.

36. The method of claim 33 further comprising:
viewing images seen by the first camera with a first viewing screen of the viewing screen system; and
viewing images seen by the second camera with a second viewing screen of the viewing screen system.

37. The method of claim 36 further comprising adjusting at least one of vertical and horizontal positions of the first and second display panels.

38. The method of claim 37 further comprising prefocusing the camera system on a reference target at a location on the longitudinal axis at a distance D₂ in order to allow the cameras to focus on the first and second display panels when viewed through the first and second lens assemblies of the binocular display device.

39. The method of claim 38 further comprising calibrating the baseline indicia to be located at the proper position on the viewing screen system by:
projecting images of the reference target viewed by the camera system on the viewing screen system; and
adjusting the position of the baseline indicia on the viewing screen system until the baseline indicia is located relative to the images of the reference target in a manner that indicates acceptable alignment.
